(19) United States
(12) Patent Application Publication
(10) Pub. No.: US 2002/0012442 A1
(43) Pub. Date: Jan. 31, 2002

(54) Acoustic device and method for driving it

(76) Inventors: Henry Azima, Cambridge (GB); Nicholas P.R. Hill, Cambridge (GB); Graham Bank, Suffolk (GB); Vladimir Gontcharov, Cambridgeshire (GB); Valerie J. Taylor, Cambridgeshire (GB)

Correspondence Address: Alan I. Cantor, FOLEY & LARDNER, Washington Harbour, 3000 K Street, N.W., Suite 500, Washington, DC, 20007-5109, US

(21) Appl. No.: 09/834,960

(22) Filed: Apr. 16, 2001

Related U.S. Application Data
(60) Provisional application No. 60/198,753, filed on Apr. 21, 2000.

(30) Foreign Application Priority Data
Apr. 14, 2000 (GB) 0009133.0

(51) Int. Cl. H04R 1/00

(52) U.S. Cl. 381/431

(57) ABSTRACT

A method of and apparatus for producing acoustic output employs a bending wave member to which a number of exciters are coupled over at least part of the area. The exciters are individually addressable to generate impulses in response to digital input that has been suitably shaped and delayed, the impulses being integrated in the panel so that a form of synchronous summation takes place by bending action making use of the dispersive properties of the device. The resulting acoustic output has a reinforced fundamental frequency and reduced harmonics.

This application claims the benefit of provisional application Ser. No. 60/198,753, filed Apr. 21, 2000.

### BACKGROUND

This application relates to an acoustic device and a method of driving it, particularly to a method of driving a resonant bending wave loudspeaker using digital pulses.

Resonant bending wave loudspeakers are becoming more and more widely available. Such speakers are described, for example, in WO97/09842 and counterpart U.S. application Ser. No. 08/707,012, filed Sep. 3, 1996. In general, such speakers include a resonant bending wave plate and a transducer mounted on the plate to convert electrical signals into mechanical vibrations. In response to analogue drive signals, the transducer excites the resonant bending wave modes in the plate, which then emit sound to create an acoustic output.

Of course, most loudspeakers known to date are not resonant bending wave loudspeakers, but conventional pistonic loudspeakers having a magnet and voice coil arranged to drive a diaphragm. Piezo electric speakers are also known.

A development of such conventional loudspeakers is the digital loudspeaker described in the published PCT patent application of Hooley, WO96/31086. This document describes a digital loudspeaker having a large number of transducers which are driven by a so called “unary” code. In such a digital loudspeaker each of the many transducers is driven by a digital signal, i.e. a signal with the value binary 0 or binary 1. The Hooley application describes a way of generating suitable digital signals. The individual digital signals are summed in the human ear, and to some extent in the 3D acoustic space, to produce a combined audio signal.

However, since the digital transducers only have access to a small part of the integration medium, distortions may occur where their summation is imperfect. The present invention has as an objective the avoidance of the problem of non-perfect summation in the 3D space.

### SUMMARY OF THE INVENTION

According to the invention, the above objective is achieved by a method of producing an acoustic output at a given frequency lying within a predetermined frequency range, the method comprising the steps of:

providing a member capable of excitation in a plurality of bending waveforms at respective frequencies distributed over the predetermined frequency range;

providing means for impulse excitation of the member at a plurality of regions of the member;

exciting those regions with impulses; and

integrating the impulses within the member so as to excite at least one selected bending waveform at the given frequency, thereby producing an acoustic output at the given frequency.

In a device according to the invention, integration of the digital impulses occurs in the plate, not in the 3D acoustic space as in the prior art. The scheme outlined above affords the possibility of performing an integration of the digital pulses in a two-dimensional mechanical excitation, rather than in the 3D acoustic space. This is much more accurate due to the reduction in the degrees of freedom of motion from 3 to 2, and the access of the digital transducer to the complete space of integration.

According to a further aspect of the invention, there is provided a method of producing an acoustic output at a given frequency lying within a predetermined frequency range, the method comprising the steps of:

providing a member capable of excitation in a plurality of bending waveforms at respective frequencies distributed over the predetermined frequency range;

providing means for impulse excitation of the member at a plurality of regions of the member; and

exciting those regions with impulses, with time delays between the impulses applied to different regions being selected to excite at least one selected bending waveform at the given frequency, thereby producing an acoustic output at the given frequency.

By spacing the regions where the transducers act close enough together, the bending waves are correlated between neighbouring transducers. Furthermore, by virtue of time delays between the impulses applied by neighbouring transducers, a bending waveform can be generated having the frequency desired for the acoustic output.

Preferably, the time delay between pulses applied to transducers may be determined by the relative phase of the selected bending wave between the pair of transducers. Moreover, the number of transducers activated may advantageously be determined by the level of an analogue signal to be reproduced. In this manner, the digital pulse transducers sum to coherently excite the plate modes, which in turn radiate acoustic energy.

Furthermore, the invention may reduce one of the problems of conventional distributed mode panels, namely that an exciter may not efficiently excite those resonant modes for which the exciter is located at a node. In contrast, the invention may allow excitation of any mode, by appropriately selecting the excited wave.

Another aspect of the invention concerns a method of producing an acoustic output at a given frequency lying within a predetermined frequency range, the method comprising the steps of:

providing a member capable of excitation in bending at a frequency lying within the predetermined frequency range;

providing means for impulse excitation of the member at a plurality of regions of the member; and

simultaneously exciting selected regions of the member to thereby excite a selected bending waveform having the given frequency and produce an acoustic output at the given frequency.

By simultaneous switching of selected actuators, a loudspeaker panel according to this second aspect of the invention can be made to resonate with a desired bending waveform having a corresponding desired bending frequency, thereby generating an acoustic output at that desired frequency.

Another aspect of the invention concerns apparatus for producing an acoustic output at a given frequency lying within a predetermined frequency range, the apparatus comprising:

a member capable of excitation in a plurality of bending waveforms at respective frequencies distributed over the predetermined frequency range; and

means for impulse excitation of the member at a plurality of regions of the member and with time delays between the impulses applied to different regions selected so as to excite at least one selected bending waveform at the given frequency, thereby producing an acoustic output at the given frequency.

Yet another aspect of the invention concerns apparatus for producing an acoustic output at a given frequency lying within a predetermined frequency range, the apparatus comprising:

a member capable of excitation in bending at a frequency lying within the predetermined frequency range; and

means for simultaneous impulse excitation of selected regions of the member to thereby excite a selected bending waveform having the given frequency and produce an acoustic output at the given frequency.

Further advantageous embodiments of the invention are set out below.

### BRIEF DESCRIPTION OF THE DRAWING

Examples that embody the best mode for carrying out the invention are described in detail below with reference to the accompanying drawing, in which:

FIGS. 1(a) and (b) are schematic side and plan views, respectively, of apparatus according to the invention;

FIGS. 2(a) and (b) are schematic illustrations of two testing regimes for the apparatus of FIG. 1;

FIG. 3 is a plot of actuation signal level against time;

FIGS. 4 and 5 illustrate variation in beam velocity level with frequency for two different values of time delay;

FIGS. 6 and 7 illustrate variation in total harmonic distortion with time delay for beam velocity and sound pressure respectively;

FIGS. 8(a) and (b) illustrate variation in the amplitude and total harmonic distortion, respectively, with number of actuators of the sound emitted from a device operated in accordance with the first aspect of the invention;

FIGS. 9(a) to (c) illustrate variation in the distortion spectra with the pulse width of the excitation signal;

FIG. 10 is a schematic view illustrating operation according to a second aspect of the invention; and

FIG. 11 is a schematic plan view of a further embodiment according to the invention.

### DETAILED DESCRIPTION

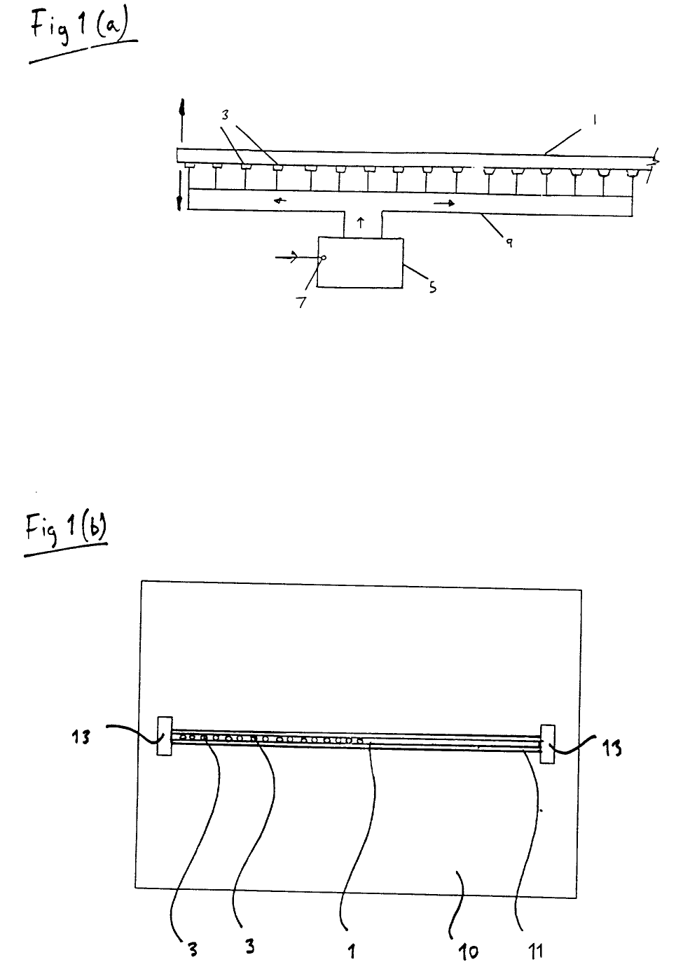

FIGS. 1(a) and 1(b) are schematic side and plan views respectively of a beam (1) much longer (at 1.2 m) than it is wide (0.02 m) which provides a plurality of resonant bending wave modes along the length of the beam. The thickness of the beam was 0.0035 m. The bending rigidity was measured experimentally by determining the bending wave velocity in the beam (using laser interferometer scanning techniques). The bending rigidity was 32.4N*m and the surface density was 0.91 kg/mˆ b 2. These parameters were used for determining the bending wave velocity at a circular frequency X using a well-known relation:

V=ω^{0.5}B^{0.25}μ^{-0.25}

Where V=bending wave velocity, B=bending rigidity and μ=surface density. The above properties were obtained by a beam having a sandwich structure and comprising an outer skin of MELINEX™, an inner skin of carbon fibre and a core of aluminium honeycomb.

Since the beam is narrow compared with its length, the bending across the beam will not be important, especially at lower frequencies. Accordingly, the specific example described represents a quasi-one-dimensional implementation of the invention. This makes driving the resonant bending wave modes much simpler.

As illustrated in FIG. 1(b), beam (1) sits in a rectangular aperture 11 formed in a baffle 10 and is softly attached to the baffle at either end by clamps 13. In the example shown, the baffle is made of medium density fibreboard and, with dimensions of 160 cm×77 cm, extends further to either side of the beam than it does to either end of the beam.

As shown figuratively at (3), a plurality of transducers are provided along one side of the beam. In this particular example, 16 inertial drive units of 25 mm overall diameter were spaced at a pitch of 40 mm along one end of the beam. Such units are well known in the art, e.g. from U.S. Pat. No. 6,192,136, and are capable of bipolar operation to exert a force in opposite directions as indicated by arrows in figure l(a).

A digital signal processor (DSP, 5) having a signal input (7) is shown, connected to the transducers by a data bus (9) . In this particular example, the sampling frequency of the DSP hardware was 40 kHz.

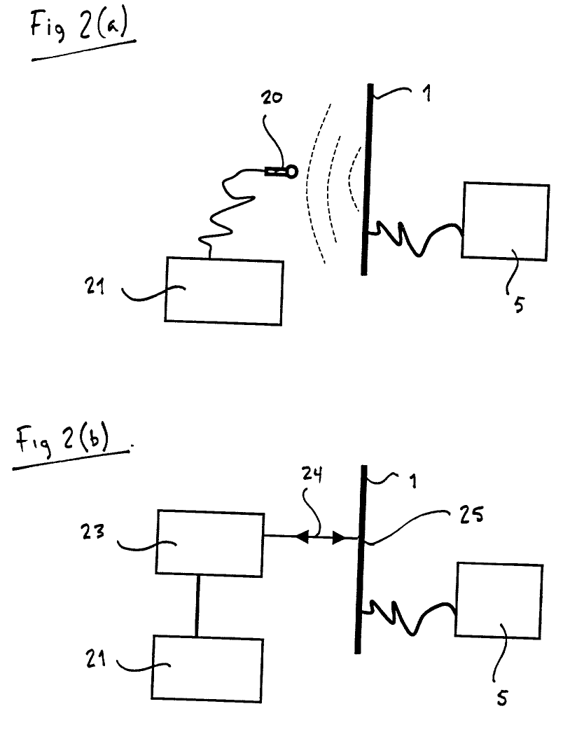

FIGS. 2(a) and 2(b) illustrate the two testing regimes for the arrangement of FIGS. 1(a) and 1(b) . The first, acoustic test (FIG. 2(a)) consisted of recording steady-state sound pressure radiated by the beam when it is pulsed. The microphone (20) was sensitive for recording distortions in the spectrum down to −80 dB. The files would be stored on a hard drive of a computer (21) and then later post processed to analyse the measured distortion spectra of the sound pressure.

In a second test (FIG. 2(b)), a laser interferometer (23) was used to record the velocity spectrum of the beam, the data again being stored and post processed on a computer (21). In order to accommodate a sensing position (25) for the laser beam (24) that is both on the beam (1) and remote (typically 0.3 m away) from the inertial exciters (3), exciters (3) are located only partially along the length of the beam.

It should be noted that the spacing between drivers affects the performance of the digital loudspeaker. The choice of the driver locations should be such that it is possible to address the highest frequency in the bandwidth of operation of the digital loudspeaker. As was mentioned before the DSP hardware in the illustration was limited to 40 kHz sampling rate giving the highest frequency of 20 kHz.

Furthermore, the spacing of adjacent exciters should not be so great that the bending wave generated by one exciter has substantially died away before it reaches the adjacent exciter: it will be appreciated that this would prevent summing/integration of the impulses within the member per the present invention.

Operation in accordance with one aspect of the invention also requires time delays between the impulses applied to regions, the time delays being selected so as to excite a bending waveform at the frequency of interest. In the present example where an acoustic output of 1 kHz is required, this time delay corresponds to a time interval that is required for a bending wave at 1 kHz to travel from one driver to its neighbour.

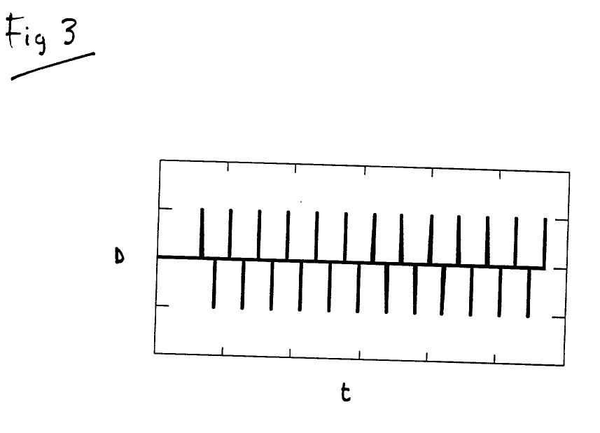

It is possible, given the material properties of the beam, to calculate using standard formulae the wave speed and hence the time delay necessary to excite any particular frequency. Alternatively, the time delay can be established experimentally, as follows. In the arrangement of FIGS. 1 and 2, this is achieved by actuating all the exciters (3) with the 1 kHz bipolar signal shown in the amplitude (D)—time (t) plot of FIG. 3 and varying the time delay between the excitement of successive actuators along the beam so as to achieve maximum acoustic output at 1 kHz.

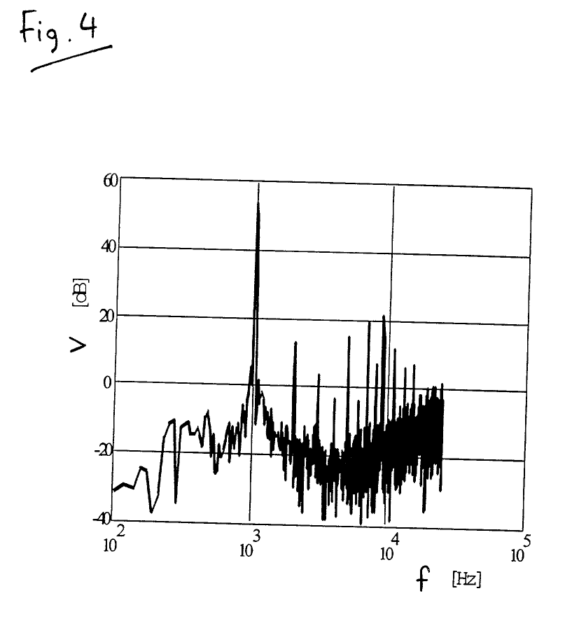

The maximum acoustic output for the arrangement of FIGS. 1 and 2 is illustrated in the plot of beam velocity level (V) against frequency (f) obtained from the laser interferometer and shown in FIG. 4. Obtained at a time delay of 0.225 ms, which corresponds to the time taken by the 1 kHz bending wave to travel the 40 mm between adjacent drivers, it will be seen that the 1 kHz signal is the main, fundamental harmonic and is some 30 dB louder than any of the other, higher order harmonics, giving a total harmonic distortion (THD) level of −20 dB.

THD (total harmonic distortion) is here defined as a difference between the level of fundamental harmonic (1 kHz in most results) and a sum of all higher order harmonics:

$$THD = - ( Fundamental - 20 \cdot log ( \sum {10}^{\frac{harmonics}{20}} ) ]$$

Where ‘Fundamental’ and ‘harmonics’ are both in dB units. The THD value is stated in dB units. Alternatively, the THD can be expressed in percents and is related to the THD in the above expression as follows:

THD%=100·10ˆ (THD/20)

Where THD is a dB value as defined in the previous equation and THD % is same expressed in percents. For example, THD=−40 dB would correspond to 1% distortion, 0 dB - to 100%.

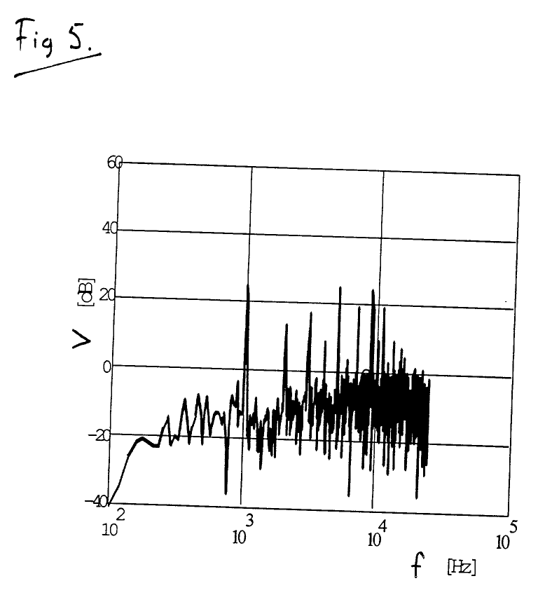

FIG. 4 can be contrasted with FIG. 5, which shows the corresponding plot for a zero time delay between impulses applied to successive regions of the beam, i.e. all exciters working in unison. It can be seen that the level of the fundamental is around 30 dB less, close to the level of the higher-order harmonics. As a result, the total harmonic distortion is significantly worse at 13 dB. Similar behaviour is evident in the sound pressure output from the beam.

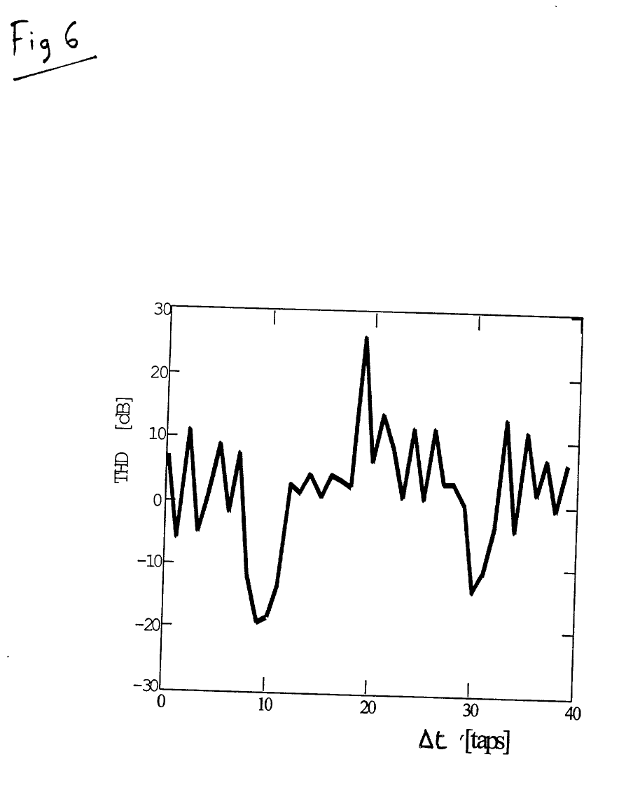

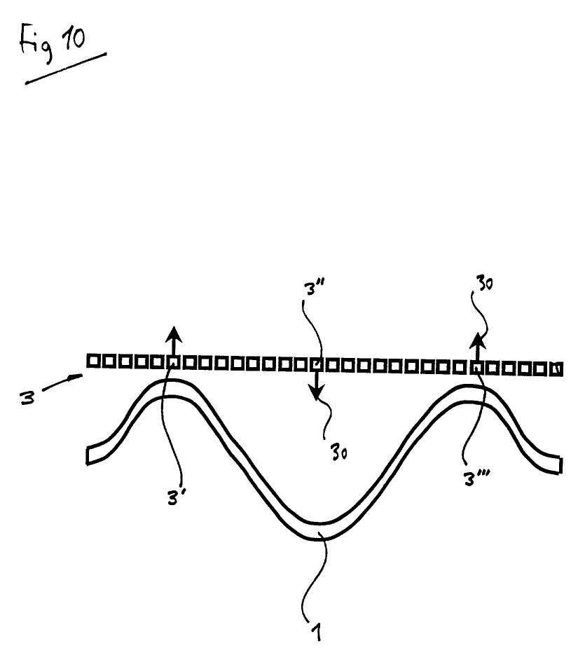

FIG. 6 shows the variation of THD over a range of time delays, At. For the 40 kHz sampling rate we have about 40 samples (taps) that constitute a 1 kHz period. Applying time delays from 0 taps (unison pulsing) to 39 taps would shift relative phases of each channel in a circle and the time delay of 40 samples will be the same as the time delay of 0. FIG. 10 shows THD levels plotted against time delays of the channels that span from 0 to 40 taps. The measurements for each time delay were carried out at a few sensor positions and presented THD levels are plotted as averages of these tests.

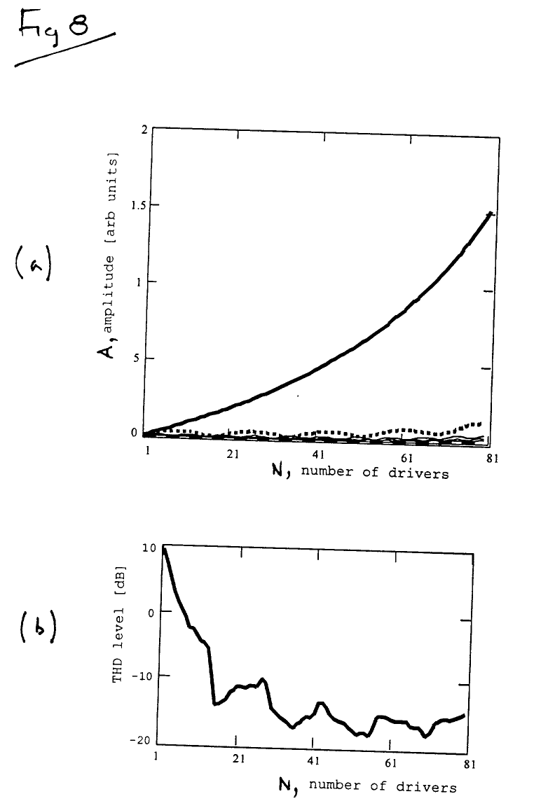

It can be seen that the minimum THD level occurs at the time delay of 9 taps (the frequency response for this measurement is plotted in FIG. 8) and 31 taps. The first THD minimum corresponds to the 0.225 ms time delay discussed above and which in turn corresponds to the travel time of the 1 kHz bending wave between transducers, at which delay all transducers reinforce the 1 kHz component of the pulse as discussed above. At 31 taps it can be seen that the mirror image of this response lies at the time delay exactly symmetrical to the 9 taps delay. (Whole wavelength at 1 kHz is 40 taps, so 31 taps would equal 9 taps as a time interval if it were assumed that the counting is from the 40^{th} tap). On average, the minimum THD level is about 30 dB lower then the THD levels at other time delay positions.

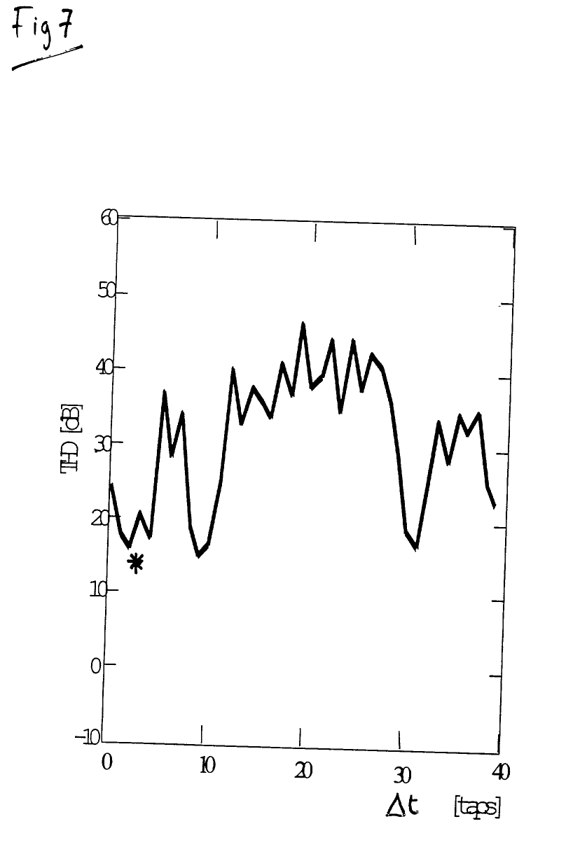

Similar advantageous behaviour to that described above is evident in FIG. 7, which shows the variation of THD with time delay when measured in terms of sound pressure using the arrangement of FIG. 2(a). This is very similar to FIG. 6 in shape although the overall level is about 35 dB higher. The difference in THD level comes from the radiation properties of structures such as beams. The typical velocity frequency response of a beam has a reasonably flat shape as a function of frequency whereas the pressure frequency response has a rising slope, and its high frequency output is normally higher than that at low frequencies. In this respect the distortion calculated from the pressure measurements will be larger than the distortion calculated from the velocity measurement. A simple shape function can be applied to the pulses to filter out the high frequency components and can be a simple low pass filter of low order. Application of such a filter to the pulse data stream can eliminate or significantly reduce high order harmonics and allow us to concentrate on frequencies at which the beam is being pulsed.

To adjust the volume of the emitted sound a variable number of transducers can be excited. For a low volume, digital pulses are applied to a small number of transducers along the length of the beam whereas for a higher volume a larger number of pulses are applied to the beam. This is illustrated in FIG. 8 which is a simulation showing effect of the number of actuated drivers N on both the amplitude A (FIG. 8(a)) and the THD level (FIG. 8(b)) of the sound emitted from a device operated in accordance with the first, “time delay” aspect of the invention. Based on 80 drivers spaced 0.97 cm apart, it can be seen that the fundamental rises fast with number of drivers since each driver is in phase with the 1 kHz wave produced by the drivers. The higher order harmonics stay low and show some periodicity on their dependence. This periodicity happens when the drivers produce outputs at higher harmonic frequencies that are only a few degrees out of phase with each other. This causes periodic rises and falls in the harmonics levels and allows the determination of a spacing between a given number of drivers so that, when they are pulsed with a correct time delay, most of the distortion harmonics will be at their minimum. This as a result may produce maximum output at the designated frequency while keeping all harmonics low. Alternatively, for a given driver spacing, an optimal number of drivers can be established at which the distortion components are all at their minimum level.

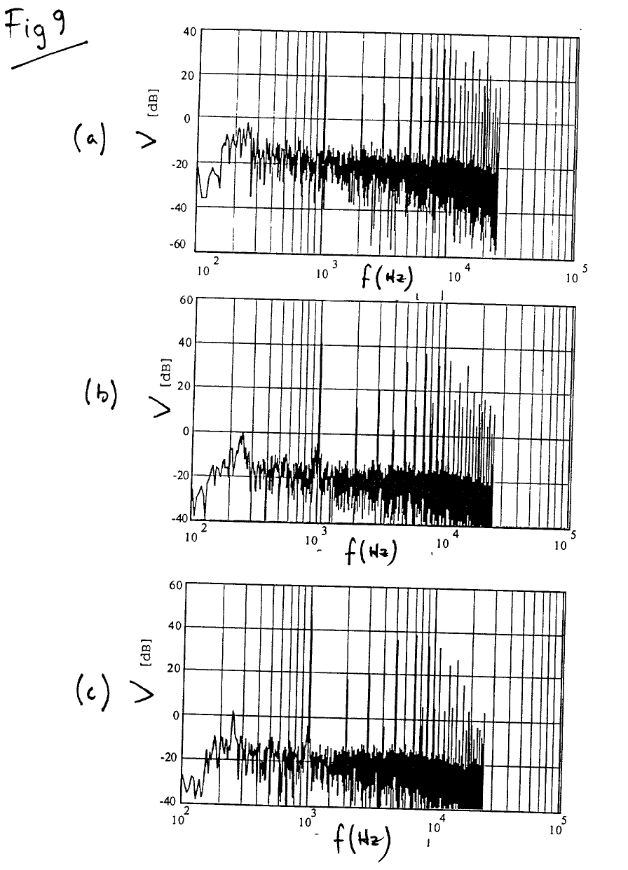

Sound levels are also affected by the width of the excitation pulses applied to the beam, as will be evident from comparison of FIGS. 9(a) to 9(c), which show the distortion spectra of a beam with 16 inertial drivers when pulsed at 1 kHz with pulses of 0.025 ms, 0.25 ms and 0.5 ms, respectively. It can be seen that as the pulse width is increased we effectively increase the amount of energy fed into the beam and as a result the overall sound levels rise. The THD changes as well since the wider pulse width is similar to application of a low order low-pass filter. A low-pass filter reduces high frequency components, which means there are fewer harmonics in the spectrum. In the three distortion spectra shown the THD levels changed from 8.4 dB to −8.5dB when pulsing the beam with 1-tap pulses and 20-tap pulses, respectively.

It is noted that the above aspect of the invention benefits from the fact that bending waves in a plate are of a dispersive nature, i.e. the wave speed is a function of wave frequency. As a result, the application of excitation pulses sequentially along a beam at a certain speed (i.e. with a certain time delay between pulses) will in turn excite a particular speed of wave having a particular frequency in preference to other waves having other frequencies and will produce an acoustic output at that frequency. It should also be noted that most structures that undergo bending vibrations are dispersive. In theory, there are five classes of various vibrations, and one of them is the kind that is referred to as “flextural” or bending. For the case of flexural waves the velocity-wavelength dependence translates into V˜f^{½} which is the case of bending waves. More information can be found in the book by J. W. S. Rayleigh, The Theory of Sound, Volume 1, Second Ed., New York, Dover Publications Inc., pp. 475-480. Dispersion is also discussed in WO97/09842 and counterpart U.S. application Ser. No. 08/707,012, the latter incorporated herein by reference.

The invention is not restricted to the excitation of one resonant bending mode or one particular frequency. The acoustic signal provided at input (7) in FIG. 1(a) may have a frequency characteristic corresponding to a number of frequencies and corresponding amplitudes. If the input signal is a conventional analogue signal, the frequency information can be obtained by a Fast Fourier Transform, or otherwise, that is well known. The correct volume for each individual frequency component can be excited simultaneously to build up an acoustic output, corresponding to the acoustic signal input. It will be appreciated that this may result in certain exciters being actuated simultaneously to generate more than one frequency.

FIG. 10 is a schematic illustration of a second aspect of the invention whereby selected regions of a member are excited so as to excite a selected bending waveform having the frequency of the desired acoustic output. As in the arrangement of FIGS. 1(a) and 1(b), there are arranged over the surface of a member 1 actuators 3 capable of exciting the member to move in both directions as indicated by arrows 30.

Given a desired range of frequencies over which the device is to produce acoustic output, i.e. the frequency range of the loudspeaker, the separation of the actuators may be chosen such that it is less than the minimum bending wavelength of the member (which occurs when the member is oscillating at the upper end of the desired frequency range) . This may in turn help ensure that even for modes at the high end of the desired range, it will be possible to excite a corresponding waveform by simultaneous operation of more than one exciter. Thus, in the case of the waveform taken up by member 1 in FIG. 10, it will be seen that this can be excited by simultaneous actuation of exciters 3′ and 3″′ in one direction and of exciter 3′ in the opposite direction.

In practice, details of the positions of the actuators required to excite waveforms corresponding to a range of frequencies of interest can be stored in a look-up table and subsequently used to drive the member in response to a frequency demand signal. When a particular frequency is pulsed, an appropriate mode is found that corresponds to this frequency. The data on this mode can be pre-calculated and stored in a bank of data (look-up table) that can be accessed by a software program. Once the antinodes of the mode are known, appropriate drivers are picked out from those on the beam. These drivers then simultaneously (that is, without time delay) output pulses of 1s and −1s thus driving the beam at this particular mode. Depending on the phases of the modeshape, some drivers may be in opposite phase to others. The requirement for the motion to be a mode is not obligatory. As long as the DSP program that controls the pulsing has the information on the shape of the motion in the beam it can arrange a suitable number of drivers to address this motion with appropriate pulsing.

As regards similarities between the two aspects of the invention, in the first aspect of the invention the time delays between the drivers are such that the waveform at a selected frequency is generated and creates a modeshape at this frequency whereas in the second aspect of the invention the drivers address the modeshape at a selected frequency directly. In this respect, both methods should give similar results and may be employed together to achieve maximum result.

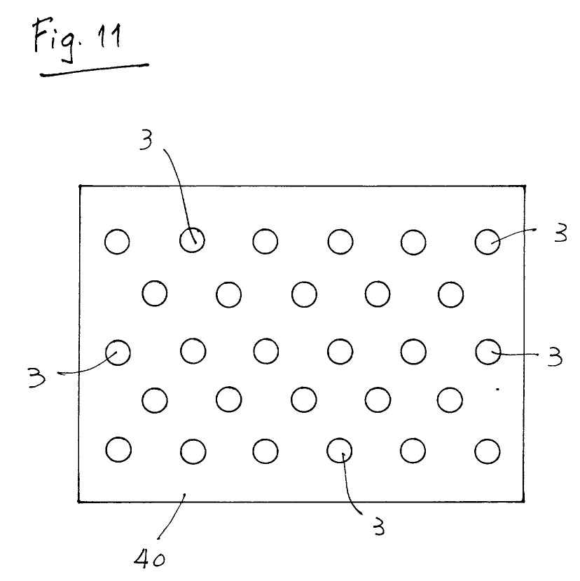

It will also be appreciated that the invention is not limited to a quasi-one-dimensional beam in which the only resonant bending wave modes within the frequency range of interest are those along the length axis of the beam. Referring, e.g., to FIG. 11, the invention can also be applied to a plate (40) with bending waves in the plane of the plate and with a plurality of transducers (3) arranged in a two-dimensional array over the plate. With a knowledge of resonant bending wave modes and the phase differences between each mode the transducers can be driven to preferentially excite modes at predetermined frequencies.

The approach to the digital summation according to the present invention is inherently linked to a controlled excitation of the individual plate modes. It therefore affords a good level of control with regard to the bending wave distribution in the plate and its radiation characteristics. In this manner it is possible to control the directivity and diffusivity of the resulting radiation, within certain constraints determined by the material parameters of the plate, by appropriate choice of transducer position, pulse shape, transducer grouping and the like.

Note that such panel constraints are not present in the prior art 3D acoustic integration model, which in principle is capable of producing a more flexible output. However, the number and density of transducers required for this to be the case makes such an implementation prohibitively complex and expensive.

Since the transducer activation may be matched to the shape of the plate mode excited, the efficiency of excitation may be very high.

Furthermore, the digital integration is no longer in the 3D acoustic space, and is therefore not strongly dependent on the position of the listener. This indicates that the listener is not limited to be in the far field, and near field applications in which the ear/loudspeaker separation is a matter of centimeters are readily possible. Telephones and headsets are particularly advantageous near-field applications.

In a digital arrangement with a small number of exciters, there may occur the problem that the individual pulses are smeared in time. This problem is linked to resonances of the individual transducers. With the correlated excitation of the plate according to the above aspect, each actuator imparts an impulse directly to the integration medium of the plate. These transducers may advantageously be made very small, with associated self-resonances far above the sampling frequency. The digital impulses are then clean and suffer less from time-smearing complications.

The principle of integration of digital pulses is facilitated by a linear integration medium: formed in the present example by a two-dimensional plate, the acoustic output from such a medium will be linearly proportional to the number of exciters that are actuated to excite the corresponding bending waveform at the frequency of the acoustic output. Many materials meet this criterion—at least over an operating range of interest—and are known and discussed for example in the aforementioned WO97/09842, U.S. application Ser. No. 08/707,012 and also in the technical paper “Distortion Mechanisms of Distributed Mode Loudspeakers” by Colloms et al, Proceedings of the 104^{TH} Acoustic Engineering Society Convention, N.Y., 1997.

It is this feature of a linear integration medium that allows the output volume to be controlled by controlling the number of transducers that are excited, as explained above with regard to FIG. 8. This is in contrast to speakers actuated by analogue means where an increase in acoustic output is achieved by an increase in exciter input. Since the only requirement of the actuator in such circumstances is that it provide a digital pulse of repeatable shape in response to a trigger signal from driver electronics, there is no need for the actuator itself to have a linear input/output characteristic.

It will be appreciated that volume variation pursuant to the above regime will be in a number of discrete steps equal to the number of bipolar transducers (or unipolar transducer pairs). This is a major influencing factor on the number of transducers employed in any given product application and hence on the spacing between adjacent transducers.

This therefore represents a scheme by which a non-linear transducer/actuator may be employed for audio reproduction without the need for pre-processing to correct for its transfer function. This opens up many possibilities for new transducer mechanisms, for example magnetostrictive materials and nematic liquid crystals.

One possibility for the non-linear transducers is a uni-polar device, for example using a nematic liquid crystal actuator. In this case it is relatively easy for an applied electric field to polarise the liquid crystal molecules and align them in the direction of the electric field. However, the time constant for the molecules to return to their rest position after the electric field is removed can be very long. This actuator is therefore efficient in producing a digital pulse of one polarity only, which makes the reproduction of bipolar audio signals very complex. A scheme by which an audio signal may be produced would require the delicate cancelling of stimuli on opposite phases of a particular mode. The inevitable mismatch in these stimuli would degrade the quality of low level signals, making this solution a poor one.

However, uni-polar devices may be employed in a bi-layer scheme. In this case one transducer layer above the symmetry line of the plate produces one polarity of force impulse, whereas an identical plane below this line produces the other polarity. In this manner, both positive and negative impulses may be produced with uni-polar actuators, which opens up the option of devices such as nematic liquid crystal actuators.

Active layers of transducer material applied to a plate together with a printed electrode represent a simple and cheap method of manufacture. Furthermore, for the case of a transparent transducer layer, such as a nematic liquid crystal, the electrode may also be patterned out of a conducting transparent film, such as indium tin oxide, forming a truly transparent loudspeaker.

As an alternative to the point forces generated by the schemes described above and shown by arrows in FIG. 10, excitation may be achieved by the application of moments. Appropriate transducers are known, for example from U.S. Pat. No. 6,192,136.

The use of stimuli applied to closely spaced exciters on a bending wave plate may give rise to good correlation between exciters and a workable digital loudspeaker. The quality of digital integration in this scheme may be greatly superior to existing concepts centred on 3D acoustic integration of the digital signal. Furthermore, this scheme may exhibit at least one of the following benefits over analogue: increased efficiency, control over directivity and diffusivity, linearisation of highly non-linear devices, ability to use uni-polar devices. As compared with alternative digital concepts, the invention may allow use in the near field, minimisation of time smearing of the digital pulse and/or ease of manufacture.

It should also be understood that the impulse excitation of a bending structure is not limited to a simple rectangular shaped pulsing. The pulses can be shaped by special devices like signal conditioners to address various effects that occur in the bending structure in the process of wave integration. One of the possible shapes of the pulses can be such that they act as a low pass filter to the response of the bending structure and therefore may reduce some of the artefacts of digital pulsing like high frequency harmonic distortions.

This invention has been described by way of examples only and it should be understood that a wide variety of modifications can be made without departing from the scope of the invention.

1. Method of producing an acoustic output at a given frequency lying within a predetermined frequency range, the method comprising the steps of:
providing a member capable of excitation in a plurality of bending waveforms at respective frequencies distributed over the predetermined frequency range;
providing means for impulse excitation of said member at a plurality of regions of said member;
exciting said regions with impulses; and
integrating said impulses within said member so as to excite at least one selected bending waveform at said given frequency, thereby producing an acoustic output at said given frequency.

2. Method of producing an acoustic output at a given frequency lying within a predetermined frequency range, the method comprising the steps of:
providing a member capable of excitation in a plurality of bending waveforms at respective frequencies distributed over the predetermined frequency range;
providing means for impulse excitation of said member at a plurality of regions of said member; and exciting said regions with impulses, with time delays between the impulses applied to different regions being selected to excite at least one selected bending waveform at said given frequency, thereby producing an acoustic output at said given frequency.

3. Method according to claim 2, wherein said time delay is substantially equal to the time taken by a bending wave at said given frequency to travel between neighbouring regions.

4. Method of producing an acoustic output at a given frequency lying within a predetermined frequency range, the method comprising the steps of:
providing a member capable of excitation in bending at a frequency lying within said predetermined frequency range;
providing means for impulse excitation of said member at a plurality of regions of said member; and
simultaneously exciting selected regions of said member to thereby excite a selected bending waveform having said given frequency and produce an acoustic output at said given frequency.

5. Method according to any one of claims 1 to 4, wherein the step of providing a member comprises providing a member having a plurality of regions spaced apart by less than the bending wavelength at the high frequency limit of said range.

6. Method according to any one of claims 1 to 4, further comprising the step of selecting the duration of each impulse so as to control the total harmonic distortion of the acoustic output.

7. Method according to any one of claims 1 to 4, further comprising the step of selecting the number of excitation impulses applied to control the volume of the acoustic output.

8. Method according to any one of claims 1 to 4, wherein the step of exciting said regions with impulses comprises using impulses generated by transducers.

9. Method according to claim 8, wherein said transducers are mounted to said regions.

10. Method according to any one of claims 1 to 4, wherein the step of exciting said regions comprises exciting said regions in a bipolar manner.

11. Method according to claim 10, wherein excitation of said regions is by pairs of unipolar exciters mounted on either side of the member and at positions corresponding to said regions.

12. Method according to any one of claims 1 to 4, wherein the step of providing a member comprises providing a member having dimensions and elastic properties such that bending waves at frequencies lying within said predetermined frequency range are restricted to one axis of the member.

13. Method according to any of claims 1 to 4, wherein the step of providing a member comprises providing a member having dimensions and elastic properties such that bending waves at frequencies lying within said predetermined frequency range occur in the plane of the member.

14. Method according to claim 13, wherein the member is in the form of a plate.

15. Method according to claim 14, wherein the step of providing means for impulse excitation comprises providing a two-dimensional array of transducers.

16. Method according to claim 13, wherein the step of providing means for impulse excitation comprises providing a two-dimensional array of transducers.

17. Method according to any one of claims 1 to 4, wherein the step of exciting said regions comprises exciting said regions so as to simultaneously produce an acoustic output at a plurality of frequencies.

18. Method according to any one of claims 1 to 4, wherein the step of providing a member comprises providing a member which is a linear integration medium.

19. Method according to any one of claims 1 to 4, wherein the step of exciting said regions comprises exciting said regions by the application of forces.

20. Method according to any one of claims 1 to 4, wherein the step of exciting said regions comprises exciting said regions by the application of bending moments.

21. Apparatus for producing an acoustic output at a given frequency lying within a predetermined frequency range, the apparatus comprising:
a member capable of excitation in a plurality of bending waveforms at respective frequencies distributed over the predetermined frequency range; and
means for impulse excitation of said member at a plurality of regions of said member and with time delays between the impulses applied to different regions selected so as to excite at least one selected bending waveform at said given frequency, thereby producing an acoustic output at said given frequency.

22. Apparatus according to claim 21, wherein said means for impulse excitation comprises control means for selecting said time delay in response to an input signal corresponding to the required frequency of acoustic output.

23. Apparatus for producing an acoustic output at a given frequency lying within a predetermined frequency range; the apparatus comprising:
a member capable of excitation in bending at a frequency lying within said predetermined frequency range; and
means for simultaneous impulse excitation of selected regions of said member to thereby excite a selected bending waveform having said given frequency and produce an acoustic output at said given frequency.

24. Apparatus according to claim 23, wherein said means for simultaneous impulse excitation comprises control means for selecting regions to be excited in response to an input signal corresponding to the required frequency of acoustic output.

25. Apparatus according to any of claims 21 to 24, wherein said means for impulse excitation comprises control means for selecting the number of regions to be excited in response to an input signal corresponding to the required volume of acoustic output.

26. Apparatus according to any of claims 21 to 24, wherein said means for impulse excitation comprises control means for selecting the duration of each impulse in response to an input signal corresponding to the required total harmonic distortion of the acoustic output.

27. Apparatus according to any of claims 21 to 24, wherein said means for impulse excitation comprises control means for selecting the number of excitation impulses applied in response to an input signal corresponding to the required volume of the acoustic output.

28. Apparatus according to any of claims 21 to 24, wherein said regions are spaced apart by less than the bending wavelength at the high frequency limit of said predetermined frequency range.

29. Apparatus according to any of claims 21 to 24, wherein said means for impulse excitation comprises transducers for exciting said regions.

30. Apparatus according to claim 29, wherein said transducers are mounted to said regions.

31. Apparatus according to claim 30, wherein said transducers are bipolar.

32. Apparatus according to claim 30, wherein pairs of unipolar transducers are mounted on either side of said member and at positions corresponding to said regions.

33. Apparatus according to claim 29, wherein said transducers are bipolar.

34. Apparatus according to claim 29, wherein pairs of unipolar transducers are mounted on either side of said member and at positions corresponding to said regions.

35. Apparatus according to any of claims 21 to 24, wherein said member has dimensions and elastic properties such that bending waves at frequencies lying within said predetermined frequency range are restricted to one axis of the member.

36. Apparatus according to any of claims 21 to 24, wherein said member has dimensions and elastic properties such that bending waves at frequencies lying within said predetermined frequency range occur in the plane of the member.

37. Apparatus according to claim 36, wherein said member is a plate.

38. Apparatus according to claim 37, wherein said means for impulse excitation comprises a two-dimensional array of transducers.

39. Apparatus according to claim 36, wherein said means for impulse excitation comprises a two-dimensional array of transducers.

40. Apparatus according to any of claims 21 to 24, wherein said member is a linear integration medium.

41. Apparatus according to any of claims 21 to 24, wherein said means for impulse excitation applies forces to said regions.

42. Apparatus according to any of claims 21 to 24, wherein said means for impulse excitation applies bending moments to said regions.

43. A near-field loudspeaker incorporating the apparatus of any one of claims 21 to 24.

44. A telephone incorporating a near-field loudspeaker according to claim 43.

45. A headset incorporating a near-field loudspeaker according to claim 43.

46. A near-field loudspeaker operating according to the method of any one of claims 1 to 4.

47. A telephone incorporating a near-field loudspeaker according to claim 46.

48. A headset incorporating a near-field loudspeaker according to claim 46.
